(19) United States
(12) Patent Application Publication
(10) Pub. No.: US 2006/0139928 A1
(43) Pub. Date: Jun. 29, 2006

(54) Container with light or sound generator

(76) Inventors: Bryn Griffiths, Surrey (GB); Jon Duncan, Middlesex (GB)

Correspondence Address: DeWitt Ross & Stevens;Intellectual Property Department, Firstar Financial Centre, 8000 Excelsior Drive Suite 401, Madison, WI, 53717-1914, US

(21) Appl. No.: 10/560,885

(22) PCT Filed: Jun. 14, 2004
(86) PCT No.: PCT/GB04/02488

§ 371 Date: Dec. 12, 2005

(30) Foreign Application Priority Data
Jun. 12, 2003 (GB) 0313627.2
Nov. 18, 2003 (GB) 026859.6
Apr. 22, 2004 (GB) 0408993.4

(51) Int. Cl. F21V 23/04

(52) U.S. Cl. 362/276

(57) ABSTRACT

A container (10), for example a drinks bottle, comprises means of producing an output such as a light signal (13) when the container is opened. Opening the container (10) causes switching of a detector circuit (20) included in the container (10), which in turn causes production of the output signal. Removing a cap (11) of the container (10) may directly close or open a switch (21, 22) within a detector circuit (20). Alternatively the switch (21, 22) may be activated by a change in pressure within the container, or by temperature. The output signal may cause illumination of the contents of the container (10) by an LED (13), or of a label (125) on the container (10), which may be constructed by an electroluminescent device (127) comprising a thin sheet of electroluminescent material.

The present invention relates to containers, and in particular to portable containers for beverages.

There is a great deal of competition between manufacturers of different brands of product to attract their target consumers. Manufacturers do not just rely on the qualities of the products themselves, but design the containers in which products are packaged to attract the consumer. This can be achieved in many ways, for example by colourful or eye-catching labelling or by the design of the shape or style of the container itself. This may apply in particular where the container is integral with the product itself, for example a container in which foodstuffs or drink may be held.

EP 1 155 972 discloses a perfume container having means for generating a sound or a light signal that may be activated at different times. The perfume container may include LEDs, which may define a figure or symbol on the casing of the container when activated. Activation occurs by a closure element of the container operating a microswitch when the container is opened. Alternatively, the LEDs can be activated when the container is lifted from a surface.

The present invention seeks to provide an output signal, which may be a significant visual or other sensory indication to a consumer on opening, or other handling, of a container.

According to a first aspect of the present invention there is provided a portable container for fluid contents including light-emitting means, event-detecting means, a self-contained power source and connecting means for connecting the light-emitting means with the event-detecting means and the power source, such that on detection of one or more predetermined events light is emitted, wherein the container is at least partially fabricated from a material able to transmit light, wherein the light-emitting means is arranged to be able to illuminate the contents of the container.

This arrangement enables automatic illumination of the contents of a container upon detection of a particular event. The effect achieved is a significant visual indication to a consumer, and may encourage the consumer to perform the event required for emission of light and hence illumination of the contents of the container.

Preferably the contents are illuminated substantially uniformly. This provides a particularly effective visual indication to the consumer.

In the preferred embodiment the container is arranged in normal use such that after detection of an event, light is emitted until the power source is exhausted. This allows the container to be used in circumstances where it would be disposed of substantially immediately after the visual effect has been provided and for short term use (for example, in a drinks bottle). Moreover, since there is no need to switch the power supply off after it has been activated, the switch can be simple.

In the preferred embodiment, the connecting means includes an electric or electronic circuit, and the event is detected by the opening or the closing of the circuit. This provides a simple mechanism for linking detection of the event with emission of light.

The connecting means preferably include substantially transparent electrically conductive means, which may comprise transparent conducting oxide material. This enables the circuitry to be arranged around the exterior of the container in a substantially invisible manner.

In preferred embodiments, the activating event comprises the opening of the container. This may be detected by a change in pressure, or by removal of an insulating tab. These provide simple mechanisms for detecting when a container has been opened. This feature causes illumination of the contents of the container once the container has been opened, and in effect provides an illumination effect whilst the container is in use.

The activating event may comprise exposure to a specific temperature or range of temperatures. This could be used to inform a consumer when a product has reached the correct temperature for consumption, or if a product has been exposed to a detrimental temperature.

The activating event could comprise exposure to a magnetic field. This would allow activation of the illumination effect by proximity to a magnet. This could be done by someone selling the container to provide the effect to a consumer, or by the consumer himself to provide the effect when desired.

The activating event could be receipt of an external signal. Such external signal could be in the form of wireless communication or of radio frequency. The external signal could originate from a mobile telephone or from a personal digital assistant. This enables remote activation of a container.

The activating event could be the removal of the container from a surface. This could be detected by release of a switch on the base of the container. This could enable illumination of the contents only during the period in which they are actually being consumed.

The activating event could be detection of touching of or near approach to the container by a person. The effect of this is that the contents of the container could be made to illuminate whilst being held by the consumer.

The light-emitting means may include at least one light-emitting diode (LED). LEDs have low power requirements.

The light-emitting means may comprise an electroluminescent device or a substantially flat light-emitting element. These can be extremely thin and flexible and permit animated displays.

In the preferred embodiment, the light-emitting means is located in an indentation external to the container. This prevents contact with the contents of the container.

The power source may also be located in the indentation. Alternatively, where a battery of substantially flat shape is used as the power source, it may be applied against a substantially planar surface of a container, such as the bottom surface or curved side surface of a bottle; such a battery would sit slightly proud of the surface of the bottle, in the manner of a label.

According to a second aspect of the present invention there is provided a portable container including light-emitting means, event-detecting means, a self-contained power source and connecting means for connecting the light-emitting means with the event-detecting means and the power source, such that on detection of one or more predetermined events light is emitted, wherein the light-emitting means comprises an electroluminescent device.

Electroluminescent devices are extremely adaptable to the required use, and can be manipulated to fit the container at the required location.

In the preferred embodiment the event is opening of the container. The container may include a symbol or logo, and the symbol or logo is illuminated. This enables illumination of the brand name and/or the label of the container, which can help the advertising of the product.

According to a third aspect of the present invention, there is provided a portable container arranged in normal use to be opened once only, including means for producing an output signal, means for detecting opening of the container, a self-contained power source and connecting means for connecting the means for producing an output signal with the means for detecting opening of the container and the power source, such that on opening of the container an output signal is emitted.

This container can be used for purposes where containers would generally be disposed of after a single use, for example, for a drinks bottle. These uses tend to be of a relatively short duration.

Preferably the container is arranged such that after opening of the container, the output signal is emitted until the power source is exhausted. This prevents the output signal lasting longer than necessary. This arrangement also allows use of a small power source and simple circuitry.

According to a fourth aspect of the present invention there is provided a portable container including means for producing an output signal, a removable insulating tab, a self-contained power source and connecting means for connecting the means for producing an output signal with the removable tab and the power source, wherein the removable tab is arranged such that on removal of the insulating tab a circuit comprising the connecting means, the means for producing an output signal and the power source is closed and an output signal is emitted.

The insulating tab prevents completion of the circuit when in place, thereby preventing production of an output signal and exhaustion of the power source. Removal of the tab allows completion of the circuit and production of the output signal.

The tab may or may not be located at or in a closure element of the container, depending on how activation of the container to produce the output signal is to be achieved.

According to a fifth aspect of the present invention, there is provided a portable container including means for producing an output signal, means for detecting temperature, a self-contained power source and connecting means for connecting the means for producing an output signal with the means for detecting temperature and the power source, such that on detection of exposure to a predetermined specific temperature or range of temperatures an output signal is emitted.

This arrangement may inform a consumer whether the product is at the correct temperature for consumption, or whether it has been exposed to temperatures that render it unsafe.

According to a sixth aspect of the present invention, there is provided a portable container including means for producing an output signal, means for detecting exposure to a magnetic field, a self-contained power source and connecting means for connecting the means for producing an output signal with the means for detecting a magnetic field and the power source, such that on detection of exposure to a magnetic field of a predetermined strength an output signal is emitted.

This arrangement would allow a consumer or other person (such as a vendor) to activate production of an output signal by bringing a magnet into the vicinity of the container.

According to a seventh aspect of the present invention, there is provided a portable container including means for producing an output signal, means for detecting receipt of an external signal, a self-contained power source and connecting means for connecting the means for producing an output signal with the means for detecting receipt of an external signal and the power source, such that on detection of receipt of an external signal an output signal is emitted.

This arrangement allows remote activation of an output signal.

The external signal may be a form of wireless communication or radio frequency. The external signal may originate from a mobile telephone, personal digital assistant, or from a radio transmission.

According to an eighth aspect of the present invention, there is provided a portable container including means for producing an output signal, means for detecting touching of or near approach to the container by a person, a self-contained power source and connecting means for connecting the means for producing an output signal with the means for detecting touching of or near approach to the container by a person and the power source, such that on detection of touching of or near approach to the container by a person an output signal is emitted.

A consumer would be able to cause production of an output signal simply by touching or being near the container.

According to a ninth aspect of the present invention, there is provided a portable container including means for producing an output signal, event-detecting means, a self-contained power source and connecting means for connecting the means for producing an output signal with the event-detecting means and the power source, such that on detection of one or more predetermined events an output signal is emitted, the connecting means including substantially transparent electrically conductive means.

In this arrangement, the connecting means can be arranged on the exterior of the container whilst remaining substantially invisible to the consumer, even on a transparent container.

In the preferred embodiment, the substantially transparent electrically conductive means comprises transparent conducting oxide material, which combines electrical conductivity with high relative transparency (transmissivity).

In the preferred embodiment, the activating event comprises the opening of the container. This provides an incentive to the consumer to buy the product and open it, in order to cause production of the output signal.

Preferably, the output signal is light. This allows a significant visual indication to be provided in a public place not only to the consumer but also other people in the vicinity, without interfering with other peoples' environment.

The container may include a symbol or logo, and the symbol or logo is illuminated. This can aid in a manufacturer's advertising. Additionally/alternatively, the container may be at least partially fabricated from a material able to transmit light and the light-emitting means is arranged to be able to illuminate the contents of the container. This provides an attractive effect for the container.

Preferred embodiments of the present invention are described below, by way of example only and with reference to the accompanying drawings, in which:

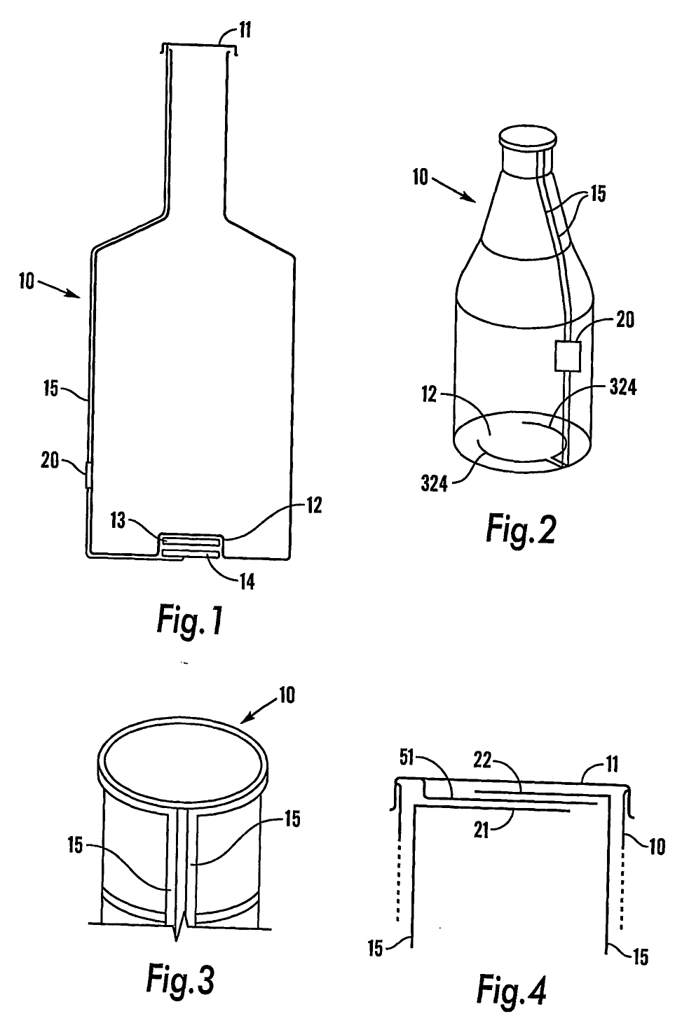

FIG. 1 is a cross-section of a bottle in accordance with a first embodiment of the present invention;

FIG. 2 is a perspective view on a reduced scale of a bottle in accordance with the first embodiment of the present invention;

FIG. 3 is an enlarged view of the top of the bottle of FIG. 2;

FIG. 4 is a diagram showing the arrangement of the terminals of a modification of the bottle of FIGS. 1 to 3;

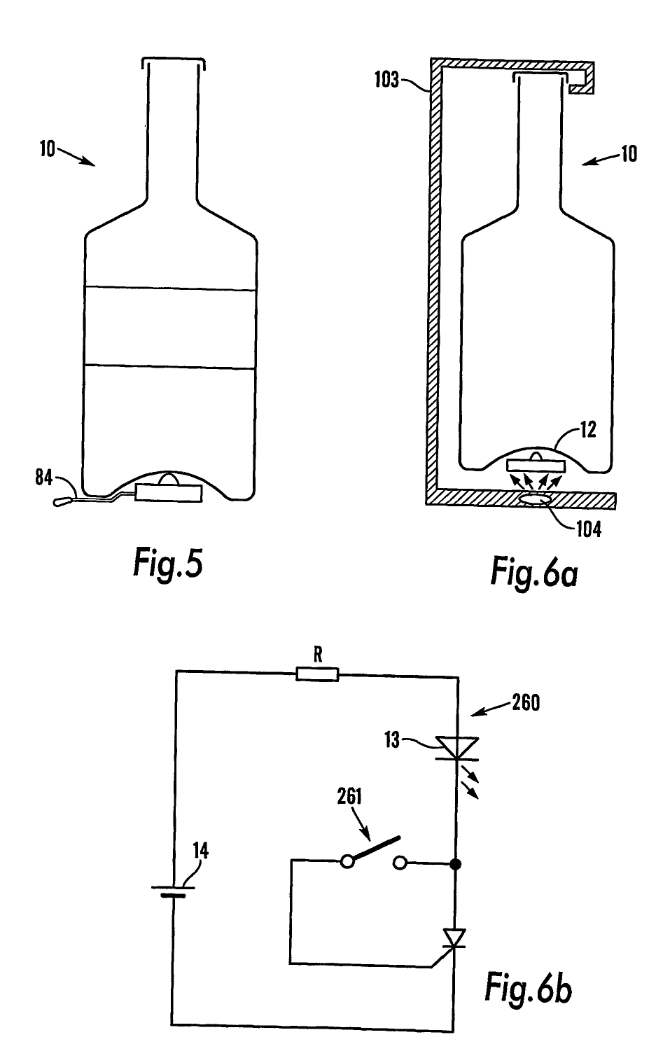

FIG. 5 is a diagram showing a further modification of the bottle of FIGS. 1 to 3;

FIG. 6a is a diagram showing a further modification of the bottle of FIGS. 1 to 3;

FIG. 6b is a circuit diagram suitable for the modification of FIG. 6a;

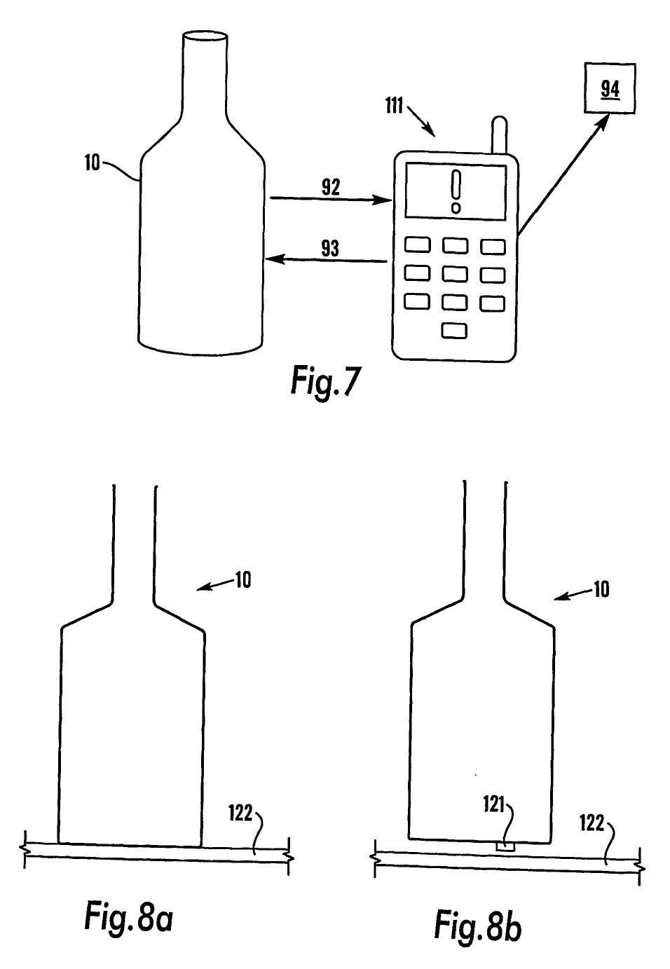

FIG. 7 is a diagram showing a further modification of the bottle of FIGS. 1 to 3;

FIG. 8 is a diagram showing a further modification of the bottle of FIGS. 1 to 3 in which the bottle is resting on a surface, FIG. 8a, and in which it has been lifted off the surface, FIG. 8b;

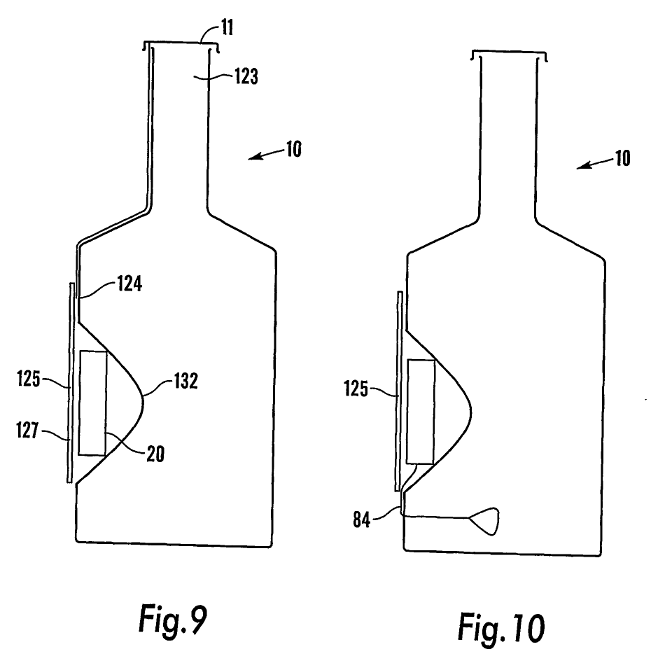

FIG. 9 is a side cross-sectional view of a bottle incorporating an illumination device in accordance with a second embodiment of the present invention;

FIG. 10 is a diagram showing a modification of the bottle of FIG. 9;

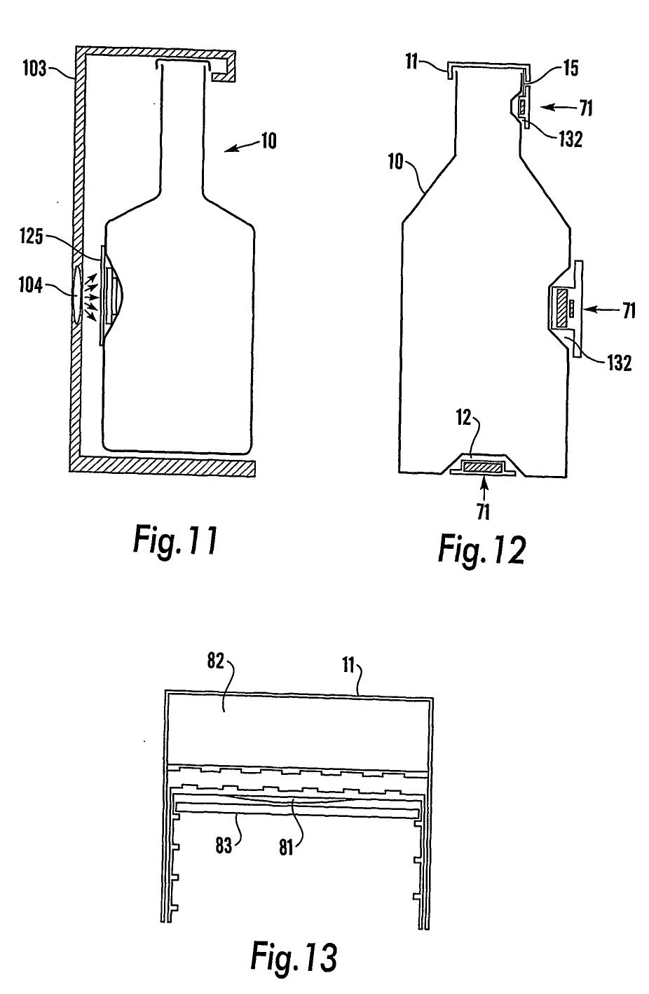

FIG. 11 is a diagram showing a modification of the bottle of FIG. 9;

FIG. 12 is a diagram showing a modification of the bottle of FIG. 9;

FIG. 13 is a diagram showing a replaceable cap in accordance with a third embodiment of the present invention.

FIG. 1 shows a disposable bottle 10, which contains a beverage, sealed by a cap 11. FIG. 2 shows the same bottle with the cap removed. The bottle is fabricated from a translucent material. The bottle has an indentation 12 in its base, in which are situated an LED 13 and coin cell batteries 14. The LED 13 and batteries 14 do not extend below the base of the bottle 10 ensuring that the bottle can rest in a stable manner on its base.

A transistor switch circuit 20 is located on the external surface of the bottle and covered by a label (not shown). Electrical conductors 15 for the circuitry are situated on the external surface of the bottle and extend to the cap 11. In this embodiment, electrical conductors 15 are of a transparent conducting oxide material such as indium tin oxide (otherwise known as tin-doped indium oxide or ITO). Another suitable material is aluminium-doped zinc oxide. These materials combine electrical conductivity with high relative transparency (transmissivity).

The bottle cap 11, when in place, makes a connection between electrical conductors 15 at the top of the bottle (see FIG. 3), the connection being broken when the bottle is opened by removing the cap. The ends 324 of electrical conductors 15 serve as connections to the control and power circuit. The control circuitry is implemented with surface mount components. The current requirement and power dissipation of the necessary devices are minimal for low current illumination; the control circuitry is therefore small and unobtrusive and could be implemented as a completely integrated circuit.

The terminals (not shown) of circuit 20 are electrically connected together by conductive cap 11 of the bottle 10 when the cap is applied to the bottle during manufacture.

In use, the bottle is of substantially conventional appearance before opening. That is, it may be difficult or impossible for a consumer to distinguish the bottle from a similar bottle that is unable to emit light. On opening the bottle of the embodiment of FIGS. 1 to 4, the electrical circuit through the cap is opened. This causes closure of the LED circuit path and emission of blue light by the LED. The non-specific location of the LED in the base causes uniform illumination of the contents, such that the contents appear to glow independently of the bottle.

In this embodiment, once the bottle has been opened, it is not possible to reform the circuit and reactivate the illumination effect. Therefore, the illumination can be activated once only. In this embodiment, the effect lasts for about 15 to 20 minutes depending on the lifetime of the batteries (i.e. until the battery power is exhausted).

There are various advantages of the above described arrangement.

The container can be subjected to cold and wet environments and is thus suitable for the drinks which are likely to be chilled in refrigerators, or even immersed in buckets of iced water. The devices used, including all the electronics, are designed to withstand these environments and therefore may be encapsulated so that operation of the electronics is not affected when they come into contact with water and moisture.

Manufacturers may wish to visually enhance containers for many reasons, including product promotion, advertising, point of sale, competition based campaigns and general marketing purposes. It could be particularly useful for launching a new brand. “Seasonal” promotion may be desired at certain times of the year (Christmas, for example). This type of visual enhancement could be used to target specific consumers. For example, it may attract certain consumers to drinking beer.

Although there would be an initial setting-up cost to provide containers as described above, on a large-scale the cost of production will be extremely small. Current manufacturers would be able to easily adapt their facilities in order to produce such containers.

In addition, this arrangement has the advantage that the conductors are substantially invisible and thus do not detract from the aesthetic look or artistic design of the bottle.

There are various modifications that can be made to the above-described embodiment.

It is particularly envisaged that the bottle contain an alcoholic beverage such as an “alcopop”, also known as RTD (ready to drink) or FMB (Flavoured Malt Beverage), or beer, although, depending on the purpose for which the present system is used the contents may be anything, solid (for example, a powder), liquid, paste, gel, or pressurised gas, ranging from foodstuffs to toxic or hazardous substances.

The invention can be used in other types of containers, for example, jars, packaging boxes, cans, packets, blister packets, bags, tins or paste dispensers that are at least partially translucent or transparent.

The best effect is obtained from a container fabricated from a translucent material such as frosted glass, or having translucent contents, because of the diffusing effect on the emitted light. However, transparent containers or contents may also be used, especially for purposes other than visual enhancement. The container could be fabricated from any form of plastic (for example, PET or PETE).

The container need not necessarily be disposable. Alternative embodiments of the invention may include a cap that is replaceable. In particular, replacing the cap could cause opening of the LED circuit, and cessation of light-emission. In this way, containers can be designed to communicate information relating to the safety of their contents or the status of the container itself, particularly where the contents are hazardous, volatile or perishable. For example, the LED may be activated if the lid of a product is not on properly, for example, on medicine bottles where child-proof tops are not on properly, or on containers containing hazardous or degradable materials.

Opening of the bottle may be detected in ways other than by simple physical breaking of the circuit by removal of the cap as described above. This is detected by the opening of the electric circuit in the embodiment of FIGS. 1 to 4. However, other methods of detecting opening of the bottle can be envisaged. For example, the event may be detected by the closing of the electronic circuit.

FIG. 4 shows the neck of the bottle 10 and cap 11 of a modified bottle. In this embodiment, a strip of insulating material 51 is attached to the cap 11 of the bottle 10 and separates the electrical terminals 21, 22. Opening of the bottle causes removal of the insulating strip and hence closure of the circuit.

Opening of the bottle could be detected by a change in pressure. For example, if the contents of the bottle are carbonated, the pressure from within the unopened bottle can act on a device, such as a membrane switch. With a chosen area of the bottle designed to be flexible, a membrane switch, or any other type of pressure sensor, can be fitted to respond to the change of internal pressure within the bottle, when the access seal is broken, thus providing a method of interfacing the action of opening the bottle with a circuit. On removal of the cap 11, the pressure in the bottle drops, and contacts come together thereby closing the circuit. Activation by change in pressure would also serve to indicate unintentional opening or leakage from the container whilst in store.

The embodiment of FIG. 4 could be modified such that it is a conducting strip (rather than an insulating strip) that is removed on opening the bottle and the circuit is opened rather than closed.

Removal of the lid or cap of the container is not the only activating event that may be detected in order to activate light-emission. The activating event may be the removal of a metal foil from around the neck of the bottle. Depending on the configuration of the circuit, other examples of activating events may be envisaged.

An insulating tab 84 could be used on the bottle 10 at regions other that at the cap 11. This would allow the consumer or other person (for example, a barman) to activate the illumination effect when desired. FIG. 5 illustrates a possible location for an insulating tab 84. Removal of the insulating tab 84 allows completion of a circuit and thus illumination.

The activating event could be a change in temperature or by the contents of the bottle attaining a specific temperature or temperature range. Such an application could be particularly useful as a product enhancement feature by indicating to a consumer that the contents of the bottle are at the ideal temperature whereby they are “ready to consume/use”. Additionally or alternatively, illumination may act as indication that the product has been exposed to a particular temperature or a temperature-range outside of a desired range for a period of time longer than specified in Health and Safety regulations. The bottle illuminates indicating that the contents are unsafe or undesirable to drink or eat or use. Illumination can thus have a product warning function.

The illumination effect may be activated by exposure of the bottle to a magnetic field. FIG. 6a shows a bottle opener 103 that has a magnet 104 in its base. In this case the bottle 10 may incorporate a circuit 260, FIG. 6b, including a reed switch 261, the contacts of which are closed momentarily when close to a magnetic field, such as that of magnet 104. A small current then passes to the gate of a thyristor 262, which causes it to latch on and LED 13 illuminates. In use, the relative positions of the magnet 104 and switch 261 ensure that, when bottle 10 is opened by a bartender, the reed switch is momentarily closed. A similar circuit is used in bottles in accordance with the modification disclosed below with reference to FIG. 11.

Activation could be by means of communication device for example a mobile telephone or personal digital assistant. FIG. 7 illustrates activation via a signal originating from a mobile phone 111. The communication from mobile telephone 111 or from any other communication device to the bottle 10 may be either digital or analogue and so may be realised by the use of modulated carriers, electromagnetic waves (visible or invisible), sound waves (audible, subsonic or ultrasonic), pulses, or via direct contact communication. In particular, this could be effected by transmission of an infra-red signal, the detection of which results in illumination of a bottle.

Activation via the receipt of an external transmitted signal, such as from a communication device, could prove very effective for competition based campaigns. For example, the bottle may contain a built in FM receiver enabling it to illuminate upon receipt of a specific radio signal, indicating that the consumer is a competition winner. The activating event can be caused by the detection of an externally transmitted signal, such as a binary code carried on a radio wave transmission or a locally transmitted electromagnetic signal, suitably arranged such that a device can recognise this signal and understand that this is an activating event, For example, during a sporting event, bottles consumed within a specific venue could be made to illuminate or flash every time a particular sports team scores.

Instead of originating from a communication device, activation could be caused by other sources. An example of sound waves coming from another source is a loudspeaker in a night club, in which a specific sound wave, such as the bass output, triggers a bottle to flash in time with the music.

A switch 121 on the base of bottle 10 that is depressed when bottle 10 is placed (FIG. 8a) on a surface 122, but released when the bottle is picked up (FIG. 8b) by a user would result in visual enhancement of the bottle whilst it is in use. If employed in a bottle of drink sold in a bar, this could encourage people to drink more quickly and therefore buy more of the product.

The human body proximity or touching effect can be exploited to activate illumination by touching of or near approach to the bottle by a person. This can be detected by a conductor located on the bottle, that is sited in a non-intrusive location (for example, it may be located under a label, or it may form a label or part of a label).

The activating event could be proximity of two or more bottles of the same type within a defined range. This may be implemented, for example, by the use of Hall-effect devices, capacitive sensors, and/or other such methods employed for the detection of physical proximity. Such activation would encourage customers to buy the same brands of beer when they are out in a group of friends i.e. it is a way of increasing the volume sold of a particular brand. The bottles are designed so that if several bottles are held close together, one of the bottles may glow a specific colour if it is a “winning” bottle indicating the customer has won a prize.

Other embodiments may utilise alternative methods of detecting activating events. These may be, for example, inductive or capacitive coupling, change in capacitance or inductance, contacts in any removable section of the bottle, direct contact with the bottle's contents, temperature activation, tamper activation, via receipt of an external signal (it could be infra red or radio frequency or other, by the known methods of modulating a carrier frequency) or other electromagnetic method.

Initial activation methods are many and varied as already covered and subsequent changes to the activated effect can also be implemented by inductive, capacitive, field effect, human body aerial effect or human body conduction. Second/third etc. stage effects can obviously be additionally implemented.

Other examples of activating events include breaking a seal, tearing off a label or a strip, removal of the foil or label covering the cap and at least part of the neck of a bottle, replacing a label, tilting of the container (for example, whilst drinking from a bottle), change in the level of the contents, or through tampering with the container or its contents. Of course, a manually activated switch could also be used to activate light-emission.

For certain of these activating methods, it may be advantageous to have an initial activating event (for example, removal of the cap or of a tab), with the described activating event being a secondary activating event (for example, the bottle reaching a suitable temperature for consumption, or the user touching the bottle). This would prevent unintended activation, say, during transit or storage of the product.

The illumination effect can be made time variable so the effect lasts for or starts after a specified period of time or after specified conditions have occurred.

The illumination effect may intermittently flicker or pulse, either at random or at regular time intervals. In this way it can be used to attract a consumer's attention to the product whilst it is still sitting on a supermarket or bar shelf. The effect can therefore be used to encourage purchase of the product.

A single LED, or any combination and colour of LEDs could be used. Because the power requirements for such an effect are minimal such an effect could last for many months. Organic LEDs may be used. Of course, a second stage effect could also be utilised such that as well as flickering on a shelf, upon opening a second stage effect was initiated, for example constant illumination of the contents.

Any colour of LED may be employed. It is preferred that clear lens LEDs are employed so that colour of the emitted light cannot be determined until after activation has occurred. This is particularly relevant where this system is employed for a promotional competition (for example, a limited number of “winning” containers may emit a different colour to regular containers).

Location of the LED “non-specifically” in the base of the container gives a good overall illumination effect. The LED may be located at any other part of the container for a non-specific illumination effect.

An electroluminescent device, which may comprise a thin sheet of electroluminescent material, may be used instead of LEDs. The electroluminescent material may be organic or inorganic and emits light when an AC or DC electric field is applied (depending on its type).

Other embodiments may utilise incandescent, fluorescent, semi-conductor or other electrically activated illumination devices. A neon light could be used. Chemical illumination may also be implemented.

Multi-coloured illumination effects may be achieved using one or more light sources. The wavelength of the emitted light may be from the visible part of the electromagnetic spectrum, or may be non-visible, such as ultraviolet light or infrared. The effect may result in the contents of the container appearing to change colour.

A liquid crystal display (LCD) device may be used; for example, an LCD may be embedded with a message. The LCD may be embedded in the container. It may have a dedicated drive circuit and could display a scrolling advertising message, or indicate that the consumer has won a prize. A flexible LCD could be used.

It is not essential to use transparent electrically conductive means for the connecting means. This will depend on the use of the bottle. However, even if the bottle is replaced by a different type of container the advantage of transparent conductors applies whether the material of the container is transparent or opaque.

If the event which is to activate the electroluminescent device is not the removal of the cap (as with the embodiment of FIGS. 1 to 4), the electrical conductors 15 do not need to extend to the top of the bottle.

Conductors may form an integral part of a label or be attached to the container. The conductors may be situated on the internal or external surface of the container, be embedded into the material of the container, or be a part of the container, or a combination of these. The moulding of the container can be designed to accommodate these features. The control circuitry may or may not be in direct contact with the contents of the container depending on the specific application.

The transistor switch circuit could be located on the internal or the external surface of the container. It could be located within a moulded indentation of the container, or embedded into the material of the container. It could be hidden under, or attached to the back of a label, or other material that is subsequently attached to the container.

The power source may comprise various types of battery, including rechargeable batteries or photoelectric cells. A battery of substantially flat configuration is preferred. The power source may also comprise clockwork generation.

In another modification, a label is printed with active ink, for example ink that is sensitive to UV (Ultra Violet) light. Using contents illumination as above but with a UV LED, the contents are illuminated, and then as a secondary process, the UV light from the illuminated contents is picked up by the UV sensitive ink in the label such that the label glows.

This provides a technically simple and cheap way of illuminating a logo since the device and power supply can all remain in the base of the container, leading to ease of production, and a normal label is used on the side of the bottle that is sensitive to a particular wavelength of light such that the ink it is printed with glows on exposure to that wavelength of light. There is no need for a device to be housed in an indentation behind the logo or symbol:

A similar approach could be adopted whereby the active ink used in the label is infrared sensitive and an infrared LED or other infrared source is used to illuminate the contents of the liquid. Infrared sensitive ink is invisible to the naked eye unless infrared radiation is passed through it. The ink may thus be used in a promotion whereby the user sees a message stating that a prize has been won once the effect has been activated. The use of infrared sensitive ink is particularly suitable with containers of brown or green glass.

The power source need not be situated within an indentation in the base of the container, but could be at any suitable location of the container. For example, a photosensitive cell could be located in darkness under the lid of the container. On opening the container, and exposure of the photosensitive cell to light, the circuit is activated and the current required for light-emission from the LED is supplied.

FIG. 9 illustrates a second embodiment of the present invention. A disposable bottle 10 having electrically conductive strips 15 applied to the exterior surface of bottle 10 between its top 123 and a side region 124 to which is applied a label 125.

Electrically conductive strips 15 are of a transparent conducting oxide material such as indium tin oxide (otherwise known as tin-doped indium oxide or ITO). Another suitable material is aluminium-doped zinc oxide. These materials combine electrical conductivity with high relative transparency (transmissivity).

Label 125 is partly or substantially wholly constructed by an electroluminescent device 127 comprising a thin sheet of electroluminescent material.

The electroluminescent device 127 is constructed using phosphor inks printed on a plastics substrate and is over-printed with printed graphics to constitute label 125. The electroluminescent material may be organic or inorganic and emits light when an AC or DC electric field is applied (depending on its type).

A control and power supply circuit 20 is provided in a recess 132 in the side wall of the bottle beneath label 125.

In use, removal of the bottle cap 11 is detected via conductive strips 15 by the circuit 20 which is activated to uniformly illuminate the whole of label 125 or a selected part thereof, for example, a part carrying a particular symbol or a logo.

In this embodiment, once the bottle has been opened, it is not possible to reform the circuit and reactivate the illumination effect. Therefore, the illumination can be activated once only. In this embodiment, the effect lasts for about 15 to 20 minutes depending on the lifetime of the batteries (i.e. until the battery power is exhausted).

There are various advantages to the above-described arrangement.

This arrangement can be applied to a conventional bottle, and need not be included during manufacture of the bottle.

Illumination of the label enables highlighting of the brand name and/or of a logo on the container. This constitutes a significant advertising tool.

An advantage of the use of the electroluminescent material is that it enables an extremely thin and flexible label to be provided and permits animated displays. Moreover, the display features, of the label are visible under normal lighting conditions so that the label can be read even without being illuminated by the circuit.

There are various modifications that can be made to the above-described embodiment.

The container can be of transparent or translucent glass or plastics material. However, it can be opaque. Instead of a bottle, it can be a box, packet, tin or other openable container and can be made of cardboard, plastics material, metal etc.

The electroluminescent device 127 may be illuminated by an event other than the opening of bottle 10, for example, removal of an insulating tab 84 (FIG. 10), the attainment of a particular temperature in which a logo or a specific “temperature icon” may illuminate, exposure to a magnetic field (FIG. 11) or the receipt of an external signal such as a predetermined radio frequency signal or a communication from a mobile telephone (as with the embodiment of FIG. 7).

It will be clear to the skilled person that any of the activation methods described as modifications of the first embodiment could also be used with respect to the second embodiment.

The label does not need to be formed from an electroluminescent device. A single LED, or any combination and colour of LEDs could be used to illuminate a symbol or logo. The LED could be embedded within a specific part of the bottle to provide independent illumination of a logo or symbol.

In a modification shown in FIG. 12, bottle 10 includes device 71 in the form of a symbol that signifies the brand of the contents of the bottle. Device 71 is moulded from plastic and is embedded with an LED, power source and control circuitry in order to effect illumination. This modification may be useful where the bottle 10 has contents likely to be consumed in daylight and/or conditions where there is a significant amount of background illumination, such that its label cannot be illuminated to a degree where the illumination is visible to the consumer (because the background illumination is so intense). High intensity illumination of the symbol is effected upon activation. Device 71 could be located at any specific part of the bottle, for example, the neck, the body or the base. An advantage of it being on the base is that it is visible to others when the consumer is actually drinking from the bottle. Three locations for device 71 are shown in FIG. 12, although it will be appreciated that only one device 71 will normally be provided.

The symbol may be a logo signifying the contents of the bottle or their brand, or it may be some other type of symbol (for example, an image of a heart or a brain). Specific characters, letters or words may be chosen for illumination. Any other specific part of the bottle may be illuminated instead of a symbol.

Alternatively the logo/symbol could be an integral part of the bottle itself, for example, an embossed or relief section of a glass bottle or a moulded piece of plastic that is part of a plastic bottle's main structure. A unit consisting of an illuminating element, power source and chip can then be attached to the bottle such that the embossed piece of glass or the moulded piece of the plastic bottle illuminates.

The logo may appear on an etched part of the bottle, its surrounding area being substantially opaque. The logo is then side-lit, and the light diffuses through the etched area, which is translucent.

Images, logos or other symbols may be projected from the container.

FIG. 13 shows an arrangement of a switch 81 and cap 11 suitable for use in a third embodiment of the invention in which the cap is replacable. A “child-proof” pill bottle cap 11 is shown. It has been modified such that the top of the inner section is fitted with a membrane switch 81. The wires from the topside of this switch 81 are fed to the circuit in the new top cavity 82 housing a power source, circuit and LED.

When the cap 11 is fitted to the container properly, the top lip of the bottle pushes up the seal 83 inside the cap, thus activating the membrane switch 81. This changes the state of the circuit to stop the warning illumination, and thereby provides a direct indication that the cap 11 has been re-fitted correctly.

This embodiment would be useful for example for containers of medicine or any type of pharmaceutical product or for containers that contain hazardous materials.

In this embodiment a flashing illumination effect has the advantage that the power source will last longer. However, a continuous illumination effect may be used.

It may be the lid or the body of the container that illuminates if the lid of the container is not replaced properly.

Alternatively, activation of the LED may attract the attention of a shopper, for example to indicate previous opening of a jar, can or bottle in a supermarket (and thus product tampering). An advantage of this system is that the consumer can tell whilst a jar is still on the shelf in the supermarket whether it has previously been opened; they will not need to wait until opening the product at home, after it has already been bought.

Preferably, in such “safety” applications, the LED would emit light for longer than 20 minutes. This can be achieved, for example, by inclusion of timing circuitry, which switches off the LED after a specified period of time. Alternatively, use of a flashing light, which may flash randomly or at regular time intervals, could save energy and therefore allow the illumination effect to last for longer. In cases where the LED has been activated for too long whilst the container was still in the supermarket and the batteries have run down, failure of the container to light up on opening at home could also indicate a problem with the contents.

A further embodiment is described in connection with FIG. 7. A bottle 10 includes a circuit containing infrared components and a power source (not shown). These are integrated into a small package, which is attached to the bottle in a convenient fashion.

Upon opening the bottle, infra-red radiation is emitted. If the consumer has a mobile telephone 11 with the facility to transmit and receive infrared signals and transfer data, it is possible to physically position the bottle 10 and the telephone 11 for communication by infrared means. The consumer switches his telephone on, sets it to infra-red mode and directs it at the bottle, which if it is a “winning” bottle, will send a message 92 to the telephone letting the consumer know he has won a prize.

One possible realisation of this concept is to have a pre-programmed logic circuit on the side of the bottle, which, when activated, transmits a call signal awaiting a response from a mobile telephone. Upon receiving that response the pre-programmed logic circuit then transmits a message 92 to the telephone such that the message is registered and remains on the telephone. The telephone then returns a handshake acknowledgement 93 to the bottle 10, which then ceases to transmit the original message 92. At this point it is determined that the message or code or data contained within the circuit of the device attached to the container has been transferred or uploaded. This may then be read as a message on a display of the telephone providing instructions for the obtaining of a prize, for example. Since the bottle has stopped transmitting it is not possible for the message or code or data to be transferred to any other telephone thus securing the validity of a once only prize from the one bottle.

The message or code or data may then be transferred to the promoters 94 for verification and the remittance of a prize, for example.

Instead of a mobile telephone, the bottle may communicate with other “communication devices” such as a personal digital assistant, or a computer. Activation of the circuit device on the container may be or by any of the methods previously outlined.

This method of adding a communicating facility to a container may also be adapted for other purposes, such as the information of contents, ingredients, place of manufacture, grade, quality, nutritional information, etc.

The communication between a container and a communication device may be either digital or analogue and so may be realised by the use of modulated carriers, electromagnetic waves (visible or invisible), sound waves (audible, subsonic or ultrasonic), pulses, or via direct contact communication, etc.

In a possible modification of the above-described embodiments, the output signal may comprise a sensory stimulation such as sound (for example, the playing of a signature tune, a jingle, an alarm buzzer or any form of audio) and could be activated instead of, or in addition to, an illumination effect. Alternatively the output signal may comprise vibration. Other types of sensory stimulation, such as release of a smell, may be envisaged.

Activation of illumination may occur prior to purchase by a consumer, for example, to attract a consumer's attention to a product before they have decided to buy the product.

Events that have been described as secondary activating events could constitute the primary activating event and vice versa.

The features of the various embodiments and modifications may be interchanged and/or combined as appropriate.

The invention has been defined in specific embodiments by way of example and the skilled addressee will understand that various items of the proposed embodiments may be varied or exchanged without departing from the scope of the invention.

1. A portable container (10) for fluid contents including light-emitting means (13, 127), event-detecting means, a self-contained power source (14) and connecting means (15, 20) for connecting the light-emitting means (13, 127) with the event-detecting means and the power source (14), such that on detection of one or more predetermined events light is emitted, wherein the container (10) is at least partially fabricated from a material able to transmit light, wherein the light-emitting means (13, 127) is arranged to be able to illuminate the contents of the container.

2. A container as claimed in claim 1, wherein the contents are illuminated substantially uniformly.

3. A container as claimed in claim 1 or 2, wherein the container (10) is arranged in normal use such that after detection of an event, light is emitted until the power source (14) is exhausted.

4. A container as claimed in claim 1, 2 or 3, wherein the activating event comprises the opening of the container.

5. A container as claimed in claim 4, wherein opening of the container is detected by removal of an insulating tab (51).

6. A container as claimed in claim 4, wherein opening of the container is detected by a change in pressure.

7. A container as claimed in claim 1, 2 or 3, wherein the activating event comprises exposure to a specific temperature or range of temperatures.

8. A container as claimed in claim 1, 2 or 3, wherein the activating event comprises exposure to a magnetic field.

9. A container as claimed in claim 1, 2 or 3, wherein the activating event is receipt of an external signal.

10. A container as claimed in claim 9, wherein the external signal is a form of wireless communication.

11. A container as claimed in claim 10, wherein the external signal is radio frequency.

12. A container as claimed in claim 10, wherein the external signal originates from a mobile telephone (111).

13. A container as claimed in claim 10, wherein the external signal originates from a personal digital assistant.

14. A container as claimed in claim 1, 2 or 3, wherein the activating event is the removal of the container (10) from a surface (122).

15. A container as claimed in claim 14, wherein removal of the container (10) from a surface (122) is detected by release of a switch (121) on the base of the container (10).

16. A container as claimed in claim 1, 2 or 3, wherein the activating event is detection of touching of or near approach to the container (10) by a person.

17. A container as claimed in any preceding claim, wherein the light-emitting means (13, 127) includes at least one light-emitting diode (13).

18. A container as claimed in claim any of claims 1 to 16, wherein the light-emitting means (13, 127) comprises an electroluminescent device (127).

19. A container as claimed in any preceding claim, wherein the light-emitting means (13, 127) is a substantially flat light-emitting element (127).

20. A container as claimed in any preceding claim, wherein the light-emitting means (13, 127) and/or the power source (14) is located in an indentation (12, 132) external to the container.

21. A container as claimed in any of claims 1 to 19, wherein the power source (14) is a battery of substantially flat shape and is applied against a substantially planar surface of the container.

22. A container as claimed in any preceding claim, wherein the connecting means (15, 20) includes an electric or electronic circuit (20), and the event is detected by the opening or the closing of the circuit (20).

23. A container as claimed in any preceding claim, wherein the connecting means (15, 20) includes substantially transparent electrically conductive means (15).

24. A container as claimed in claim 23, wherein the substantially transparent electrically conductive means (15) comprises transparent conducting oxide material.

25. A portable container (10) including light-emitting means (13, 127), event-detecting means, a self-contained power source (14) and connecting means (15, 20) for connecting the light-emitting means (13, 127) with the event-detecting means and the power source (14), such that on detection of one or more predetermined events light is emitted, wherein the light-emitting means comprises an electroluminescent device (127).

26. A container as claimed in claim 25, wherein the event is opening of the container (10).

27. A container as claimed in claim 25 or 26, wherein the container (10) includes a symbol or logo, and the symbol or logo is illuminated.

28. A portable container (10) arranged in normal use to be opened once only, including means for producing an output signal (13, 127), means for detecting opening of the container (10), a self-contained power source (14) and connecting means (15, 20) for connecting the means for producing an output signal (13, 127) with the means for detecting opening of the container (10) and the power source (14), such that on opening of the container (10) an output signal is emitted.

29. A container as claimed in claim 28, wherein the container (10) is arranged such that after opening of the container (10), the output signal is emitted until the power source (14) is exhausted.

30. A container as claimed in claim 27 or 28, wherein opening of the container (10) is detected by removal of an insulating tab (51).

31. A container as claimed in claim 27 or 28, wherein opening of the container (10) is detected by a change in pressure.

32. A portable container (10) including means for producing an output signal (13, 127), a removable insulating tab (51, 84), a self-contained power source (14) and connecting means (15, 20) for connecting the means for producing an output signal (13, 127) with the removable tab (51, 84) and the power source (14), wherein the removable tab (51, 84) is arranged such that on removal of the insulating tab (51, 84) a circuit comprising the connecting means (15, 20), the means for producing an output signal (13, 127) and the power source (14) is closed and an output signal is emitted.

33. A container as claimed in claim 32, wherein the tab (51) is located at or in a closure element of the container.

34. A container as claimed in claim 32, wherein the location of the tab (84) on the container is spaced from a closure element of the container.

35. A portable container (10) including means for producing an output signal (13, 127), means for detecting temperature, a self-contained power source (14) and connecting means (15, 20) for connecting the means for producing an output signal (13, 127) with the means for detecting temperature and the power source (14), such that on detection of exposure to a predetermined specific temperature or range of temperatures an output signal is emitted.

36. A portable container (10) including means for producing an output signal (13, 127), means for detecting exposure to a magnetic field, a self-contained power source (14) and connecting means (15, 20) for connecting the means for producing an output signal (13, 127) with the means for detecting a magnetic field and the power source (14), such that on detection of exposure to a magnetic field of a predetermined strength an output signal is emitted.

37. A portable container (10) including means for producing an output signal (13, 127), means for detecting receipt of an external signal, a self-contained power source (14) and connecting means (15, 20) for connecting the means for producing an output signal (13, 127) with the means for detecting receipt of an external signal and the power source (14), such that on detection of receipt of an external signal an output signal is emitted.

38. A container as claimed in claim 37, wherein the external signal is a form of wireless communication.

39. A container as claimed in claim 37 or 38, wherein the external signal is radio frequency.

40. A container as claimed in claim 37 or 38, wherein the external signal originates from a mobile telephone (111).

41. A container as claimed in claim 37 or 38, wherein the external signal originates from a personal digital assistant.

42. A portable container (10) including means for producing an output signal (13, 127), means for detecting touching of or near approach to the container (10) by a person, a self-contained power source (14) and connecting means (15, 20) for connecting the means for producing an output signal (13, 127) with the means for detecting touching of or near approach to the container (10) by a person and the power source (14), such that on detection of touching of or near approach to the container (10) by a person an output signal is emitted.

43. A portable container (10) including means for producing an output signal (13, 127), event-detecting means, a self-contained power source (14) and connecting means (15, 20) for connecting the means for producing an output signal (13, 127) with the event-detecting means and the power source (14), such that on detection of one or more predetermined events an output signal is emitted, the connecting means (15, 20) including substantially transparent electrically conductive means (15).

44. A container as claimed in claim 43, wherein the substantially transparent electrically conductive means (15) comprises transparent conducting oxide material.

45. A container as claimed in claim 43 or 44, wherein the activating event comprises the opening of the container.

46. A container as claimed in any of claims 28 to 45, wherein the output signal is light.

47. A container as claimed in any of claims 28 to 46, wherein the container (10) includes a symbol or logo, and the symbol or logo is illuminated.

48. A container as claimed in any of claims 28 to 46, wherein the container (10) is at least partially fabricated from a material able to transmit light and the light-emitting means (13, 127) is arranged to be able to illuminate the contents of the container (10).
